(19) United States
(12) Patent Application Publication
(10) Pub. No.: US 2015/0131428 A1
(43) Pub. Date: May 14, 2015

(54) METHOD AND APPARATUS FOR RECOVERING ERROR IN RDM PROTOCOL

(71) Applicant: Electronics and Telecommunications Research Institute, Daejeon (KR)

(72) Inventors: Sang-Kyu LIM, Daejeon (KR); In-Su KIM, Daejeon (KR); Tae-Gyu KANG, Daejeon (KR); Il-Soon JANG, Daejeon (KR)

(21) Appl. No.: 14/530,976

(22) Filed: Nov. 3, 2014

(30) Foreign Application Priority Data
Nov. 12, 2013 (KR) 10-2013-0136787
Aug. 7, 2014 (KR) 10-2014-0101737

(51) Int. Cl. H04L 1/08; H04L 12/26

(52) U.S. Cl. CPC H04L 1/08; H04L 43/0835
USPC 370/216

(57) ABSTRACT

Disclosed herein is a method and apparatus that are capable of retransmitting lost RDM packets in RDM protocol to control various devices connected to DMX512 network. The method recovers an error in a remote controller for remotely controlling devices connected to DMX512 network via RDM protocol based on the DMX512 network. A RDM packet to be transmitted to each device is stored in a buffer, and then the RDM packet is transmitted to the device. A preset period of time is waited for so as to receive a response packet from the device. If the response packet is received within the preset period of time, a transaction number of the response packet is checked, and a sequence of the response packet with respect to previously arrived response packets is determined The corresponding RDM packet is retransmitted depending on a result of determination of the sequence.

### CROSS REFERENCE TO RELATED APPLICATION

This application claims the benefit of Korean Patent Application No. 10-2013-0136787 filed on Nov. 12, 2013 and 10-2014-0101737, filed on Aug. 7, 2014, which are hereby incorporated by reference in its entirety into this application.

### BACKGROUND OF THE INVENTION

1. Technical Field

The present invention relates generally to a method and apparatus to recover errors in Remote Device Management (RDM) protocol and, more particularly, to a method and apparatus that can define a retransmission mechanism for the error or loss of control messages transmitted in a RDM protocol which focuses on the transmission of device control messages over Digital Multiplex(DMX)512 network.

2. Description of the Related Art

In conventional technology, Remote Device Management (RDM) protocol transfers device control messages(that is, RDM packets) which are required to control devices including lighting devices connected to DMX512 network or dimmers used for adjust lighting brightness, from a controller to the respective devices.

A controller generates RDM packets so as to change the states of specific or various devices, and transfers the corresponding packets to the devices, thus transferring the commands of the controller.

Further, after each device receives a RDM packet, it determines whether the change of the state of the corresponding device is possible, and sends a related response message after changing the state if it is determined that the change of the state is possible, whereas it makes a response as a Negative Acknowledgement (NACK) message if it is determined that the change of the state is impossible. The corresponding RDM packet includes a reason code indicating the reason for such impossibility.

However, the conventional RDM protocol does not define a retransmission mechanism for coping with the loss or error of a transmitted RDM packet. Due thereto, a RDM packet that cannot be processed or that is lost due to the occurrence of an error is not recovered, and a request for the state change or state information of a device, included in the corresponding RDM packet, is not accepted.

As related preceding technology, Korean Patent Application Publication No. 2011-0061069 (entitled “Light Emitting Diode (LED) lighting equipment supporting DMX-512 communication protocol”) discloses technology in which the entire lighting control system is simply configured, thus facilitating the installation and construction of lighting control systems and contributing to the reduction of costs.

The invention disclosed in Korean Patent Application Publication No. 2011-0061069 is applied to lighting control in DMX512 (American National Standards Institute: ANSI E1. 11) protocol environment, and performs lighting control in such a way that each piece of lighting equipment connected to a DMX512 (ANSI E1. 11) communication protocol master device extracts only data corresponding to its own channel from pieces of DMX512 data generated by the master device without having to separately set the sequence of channels of respective pieces of LED lighting equipment, thus supporting DMX512 communication protocol that does not include channel setting elements.

As another related preceding technology, U.S. Patent Application Publication No. 2012-0161642 (entitled “Lighting control method and device”) discloses technology for preventing erroneous light emission and then preventing anti-light pollution because lighting control data can be verified when remote lighting control is performed over a network.

The invention disclosed in U.S. Patent Application Publication No. 2012-0161642 verifies lighting control data and merely indicates an abnormal state corresponding to an error if the error is present in the lighting control data, and does not present a retransmission mechanism for the error or loss of control messages transmitted in RDM protocol which focuses on the transmission of device control messages on DMX512 network.

### SUMMARY OF THE INVENTION

Accordingly, the present invention has been made keeping in mind the above problems occurring in the prior art, and an object of the present invention is to provide a method and apparatus that are capable of retransmitting lost RDM packets in RDM(Remote Device Management) protocol based on DMX512 network.

In accordance with an aspect of the present invention to accomplish the above object, there is provided an error recovery method in Remote Device Management (RDM) protocol, the error recovery method recovering an error in a remote controller for remotely controlling devices connected to Digital Multiplex (DMX) 512 network via RDM protocol, including transmitting a RDM packet to the device; if a response packet is received from the device within a preset period of time, determining a sequence of the response packet with respect to previously arrived response packets; and retransmitting the corresponding RDM packet depending on a result of determination of the sequence of the response packet with respect to the previously arrived response packets.

Determining a sequence of the response packet with respect to previously arrived response packets may include checking a transaction number of the response packet.

Retransmitting the corresponding RDM packet may include, if it is determined that a sequence error, in which the sequence is disrupted and a missing number appears between transaction numbers, has occurred, retransmitting a RDM packet having a transaction number corresponding to the missing number.

The error recovery method may further include, before transmitting the RDM packet to the device, storing the RDM packet.

The error recovery method may further include, if, as a result of the checking of the transaction number, a sequence error has not occurred, deleting a RDM packet having a transaction number identical to that of the response packet.

The error recovery method may further include, if a response packet is not received from the device within the preset period of time, determining whether a RDM packet to be additionally transmitted is present.

The error recovery method may further include, if the RDM packet to be additionally transmitted is present, transmitting the RDM packet to the device.

In accordance with another aspect of the present invention to accomplish the above object, there is provided an error recovery apparatus in Remote Device Management (RDM) protocol, including a transmission unit configured to transmit a RDM packet to each device connected to Digital Multiplex (DMX) 512 network via RDM protocol; a response packet reception unit configured to receive a response packet from the device; and a control unit configured to, if the response packet of the device is received within a preset period of time, determine a sequence of the response packet with respect to previously arrived response packets, and retransmit the corresponding RDM packet depending on a result of determination of the sequence.

The control unit may be configured to check a transaction number of the response packet to determine the sequence of the response packet with respect to previously arrived response packets.

The control unit may be configured to, if it is determined that a sequence error, in which the sequence is disrupted and a missing number appears between transaction numbers, has occurred, retransmit the RDM packet having a transaction number corresponding to the missing number.

The error recovery apparatus may further include a buffer configured to store the RDM packet to be transmitted.

The control unit may be configured to, if, as a result of the checking of the transaction number, a sequence error has not occurred, delete a RDM packet having a transaction number identical to that of the response packet.

The control unit may be configured to, if a response packet is not received from the device within the preset period of time, determine whether a RDM packet to be additionally transmitted is present.

The control unit may be configured to, if the RDM packet to be additionally transmitted is present, transmit the RDM packet to the device.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a DMX512 network system to which the present invention is applied;

FIG. 2 illustrates an embodiment of the internal configuration of a remote controller shown in FIG. 1; and

FIG. 3 is a flowchart showing an error recovery method in RDM protocol according to an embodiment of the present invention.

### DESCRIPTION OF THE PREFERRED EMBODIMENTS

The present invention may be variously changed and may have various embodiments, and specific embodiments will be described in detail below with reference to the attached drawings.

However, it should be understood that those embodiments are not intended to limit the present invention to specific disclosure forms and they include all changes, equivalents or modifications included in the spirit and scope of the present invention.

The terms used in the present specification are merely used to describe specific embodiments and are not intended to limit the present invention. A singular expression includes a plural expression unless a description to the contrary is specifically pointed out in context. In the present specification, it should be understood that the terms such as “include” or “have” are merely intended to indicate that features, numbers, steps, operations, components, parts, or combinations thereof are present, and are not intended to exclude a possibility that one or more other features, numbers, steps, operations, components, parts, or combinations thereof will be present or added.

Unless differently defined, all terms used here including technical or scientific terms have the same meanings as the terms generally understood by those skilled in the art to which the present invention pertains. The terms identical to those defined in generally used dictionaries should be interpreted as having meanings identical to contextual meanings of the related art, and are not interpreted as being ideal or excessively formal meanings unless they are definitely defined in the present specification.

Embodiments of the present invention will be described in detail with reference to the accompanying drawings. In the following description of the present invention, the same reference numerals are used to designate the same or similar elements throughout the drawings and repeated descriptions of the same components will be omitted.

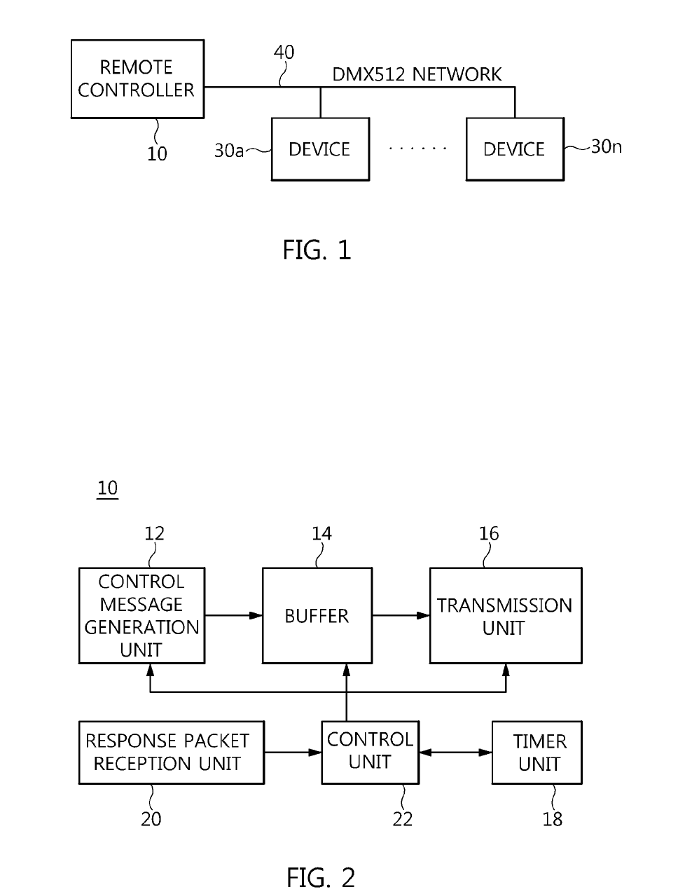

FIG. 1 is a diagram showing a DMX512 network system to which the present invention is applied.

The DMX512 network system includes a plurality of devices 30a to 30n, a remote controller 10, and a DMX512 network 40 for connecting the lighting devices to the remote lighting controller.

Each of the devices 30a to 30n may have an identifier (ID) to be distinguished from other devices.

The remote controller 10 transmits RDM packets to the devices 30a to 30n over the DMX512 network 40. Each of the devices 30a to 30n can be a lighting luminaire or a dimmer to control the brightness of lighting luminaire.

The DMX512 network 40 transfers the RDM packet from the remote controller 10 to the devices 30a to 30n.

FIG. 2 illustrates an embodiment of the internal configuration of the remote controller shown in FIG. 1. In FIG. 2, the remote controller 10 utilizes a transaction number in each packet, which has been present for mapping between a request message and a response message in existing RDM control messages.

The remote controller 10 shown in FIG. 2 includes a control message generation unit 12, a buffer 14, a transmission unit 16, a timer unit 18, a response packet reception unit 20, and a control unit 22.

The control message generation unit 12 generates RDM packets to be sent to the respective devices 30a to 30n.

The buffer 14 stores the RDM packets, generated by the control message generation unit 12, for respective packets.

The transmission unit 16 sends RDM packets to be sent, which are stored in the buffer 14, to the corresponding devices 30a to 30n through the DMX512 network 40. That is, the transmission unit 16 may be regarded as transmitting RDM packets stored in the buffer 14 to the corresponding devices 30a to 30n using RDM protocol based on DMX512 network.

The timer unit 18 measures time. The timer unit 18 transmits measured time data to the control unit 22.

The response packet reception unit 20 receives response packets from the devices 30a to 30n through the DMX512 network 40.

The control unit 22 stores, in the buffer 14, RDM packets to be transmitted to the devices 30a to 30n, and thereafter transmits the RDM packets to the devices 30a to 30n. Further, if a response packet from the corresponding device (one of the devices 30a to 30n) is received within a preset time based on the time data measured by the timer unit 18, the control unit 22 checks the transaction number of the response packet, and determines the sequence of the response packet with respect to previously arrived response packets. The control unit 22 retransmits the corresponding RDM packet depending on the result of the determination of the sequence.

Preferably, if it is determined that a sequence error in which the sequence is disrupted and a missing number appears between transaction numbers has occurred, the control unit 22 searches the buffer 14 for a RDM packet having a transaction number corresponding to the missing number, and retransmits the found RDM packet.

Meanwhile, as a result of the determination of the sequence, if a sequence error has not occurred, the control unit 22 deletes a RDM packet having the transaction number identical to that of the response packet from the buffer 14. That is, since the RDM packet having the transaction number identical to that of the response packet for which a sequence error has not occurred is data that does not need to be retransmitted, it is preferable to delete the data for the optimization of a buffer capacity from the standpoint of efficiency of resource management.

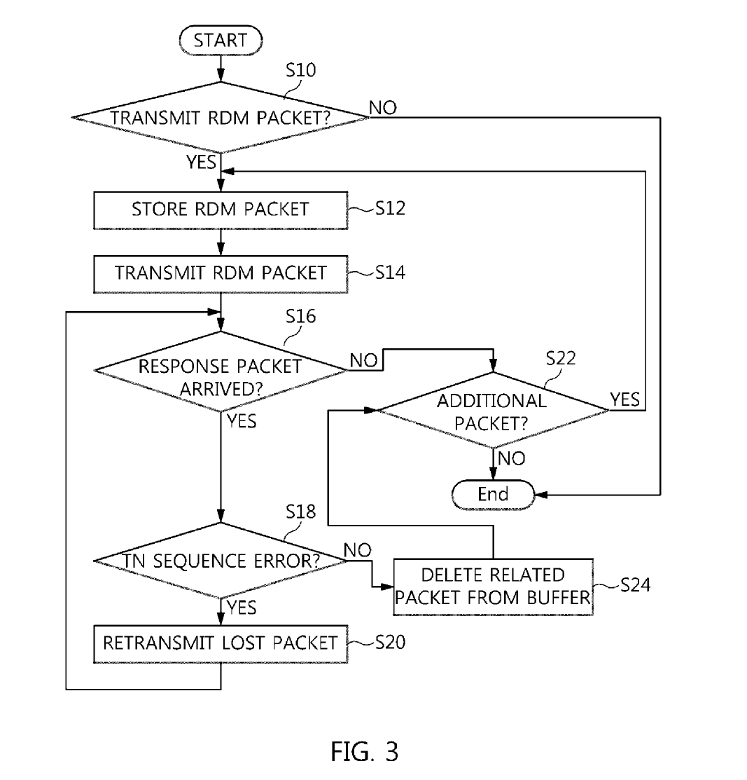

FIG. 3 is a flowchart showing an error recovery method in RDM protocol according to an embodiment of the present invention. The error recovery method in FIG. 3 may be understood to be the operation of the remote controller 10 shown in FIG. 2.

First, the remote controller 10 determines when RDM packets are sent to the devices 30a to 30n. When the remote controller 10 determines to send RDM packets to the devices 30a to 30n (“Yes” at step S10), the control unit 22 in the remote controller 10 stores a RDM packet to be transmitted in the buffer 14 at step S12. Here, the RDM packet to be transmitted may include a single packet or a plurality of packets arranged in series.

Then, the control unit 22 transmits the corresponding RDM packet to each of the devices 30a to 30n by controlling the transmission unit 16 at step S14.

Thereafter, the control unit 22 waits for a preset period of time so as to receive a response packet from the corresponding device. In this case, whether a preset period of time has been reached may be determined based on the measured time data received from the timer unit 18.

If the response packet has arrived within the preset period of time (“Yes” at step S16), the control unit 22 checks the transaction number (TN) of the response packet, and determines the sequence of the response packet with respect to previously arrived response packets.

As a result of the determination of the sequence, if the sequence is disrupted and a missing number appears between transaction numbers, the control unit 22 determines that a sequence error for transaction numbers has occurred (“Yes” at step S18), searches the buffer 14 for a RDM packet having the corresponding transaction number (TN), and retransmits the packet through the transmission unit 16 at step S20. Thereafter, the control unit 22 returns to step S16, and again waits for a response to be received.

Meanwhile, if a response packet has not arrived (“No” at step S16), the control unit 22 of the remote controller 10 determines whether a RDM packet to be additionally transmitted in this state is present at step S22. As a result of the determination, if the RDM packet to be additionally transmitted is present, the control unit 22 returns to the above-described step S12 for performing the operation of storing the packet and subsequent operations.

Meanwhile, as a result of the checking of the transaction number at step S18, if a sequence error has not occurred, the control unit 22 deletes a RDM packet having a transaction number identical to that of the response packet from the buffer 14 at step S24, and returns to the step S22 of transmitting an additional RDM packet. Since a RDM packet having the transaction number identical to that of the response packet for which a sequence error has not occurred is data that does not need to be retransmitted, it is preferable to delete the data from the buffer 14 from the standpoint of efficiency of resource management.

In accordance with the present invention having the above configuration, when a RDM packet to be transmitted for controlling various devices connected to DMX512 network is lost, the reliability of packet transmission is improved by the retransmission mechanism of this invention, thus the devices are efficiently controlled.

As described above, optimal embodiments of the present invention have been disclosed in the drawings and the specification. Although specific terms have been used in the present specification, these are merely intended to describe the present invention and are not intended to limit the meanings thereof or the scope of the present invention described in the accompanying claims. Therefore, those skilled in the art will appreciate that various modifications and other equivalent embodiments are possible from the embodiments. Therefore, the technical scope of the present invention should be defined by the technical spirit of the claims.

What is claimed is:

1. An error recovery method in Remote Device Management (RDM) protocol, the error recovery method recovering an error in a remote controller for a remotely controlling device connected to Digital Multiplex (DMX) 512 network via RDM protocol, comprising:
transmitting a RDM packet to the device;
if a response packet is received from the device within a preset period of time, determining a sequence of the response packet with respect to previously arrived response packets; and
retransmitting the corresponding RDM packet depending on a result of determination of the sequence of the response packet with respect to the previously arrived response packets.

2. The error recovery method of claim 1, wherein determining a sequence of the response packet with respect to previously arrived response packets comprises checking a transaction number of the response packet.

3. The error recovery method of claim 2, wherein retransmitting the corresponding RDM packet comprises, if it is determined that a sequence error, in which the sequence is disrupted and a missing number appears between transaction numbers, has occurred, retransmitting a RDM packet having a transaction number corresponding to the missing number.

4. The error recovery method of claim 2, further comprising, before transmitting the RDM packet to the device, storing the RDM packet.

5. The error recovery method of claim 4, further comprising, if, as a result of the checking of the transaction number, a sequence error has not occurred, deleting a RDM packet having a transaction number identical to that of the response packet.

6. The error recovery method of claim 1, further comprising, if a response packet is not received from the device within the preset period of time, determining whether a RDM packet to be additionally transmitted is present.

7. The error recovery method of claim 6, further comprising, if the RDM packet to be additionally transmitted is present, transmitting the RDM packet to the device.

8. An error recovery apparatus in Remote Device Management (RDM) protocol, comprising:
a transmission unit configured to transmit a RDM packet to each device connected to Digital Multiplex (DMX) 512 network via RDM protocol;
a response packet reception unit configured to receive a response packet from the device; and
a control unit configured to, if the response packet from the device is received within a preset period of time, determine a sequence of the response packet with respect to previously arrived response packets, and retransmit the corresponding RDM packet depending on a result of determination of the sequence.

9. The error recovery apparatus of claim 8, wherein the control unit is configured to check a transaction number of the response packet to determine the sequence of the response packet with respect to previously arrived response packets.

10. The error recovery apparatus of claim 9, wherein the control unit is configured to, if it is determined that a sequence error, in which the sequence is disrupted and a missing number appears between transaction numbers, has occurred, retransmit the RDM packet having a transaction number corresponding to the missing number.

11. The error recovery apparatus of claim 9, further comprising a buffer configured to store the RDM packet to be transmitted.

12. The error recovery apparatus of claim 11, wherein the control unit is configured to, if, as a result of the checking of the transaction number, a sequence error has not occurred, delete a RDM packet having a transaction number identical to that of the response packet.

13. The error recovery apparatus of claim 8, wherein the control unit is configured to, if a response packet is not received from the device within the preset period of time, determine whether a RDM packet to be additionally transmitted is present.

14. The error recovery apparatus of claim 13, wherein the control unit is configured to, if the RDM packet to be additionally transmitted is present, transmit the RDM packet to the device.
